(19) United States
(12) Patent Application Publication
(10) Pub. No.: US 2018/0134447 A1
(43) Pub. Date: May 17, 2018

(54) CONTAINER WITH AND CONTAINER ASSEMBLY WITH ENGAGABLE CAP

(71) Applicant: Stacked Wines, LLC, Anaheim, CA (US)

(72) Inventor: MATT ZIMMER, Newport Beach, CA (US)

(73) Assignee: Stacked Wines, LLC, Anaheim, CA (US)

(21) Appl. No.: 15/810,685

(22) Filed: Nov. 13, 2017

Related U.S. Application Data
(60) Provisional application No. 62/423,059, filed on Nov. 16, 2016.

(51) Int. Cl. B65D 21/02; B65D 85/72; B65D 23/08; B65D 43/02; C12G 1/00

(52) U.S. Cl. CPC B65D 21/0231; B65D 85/72; C12G 1/00; B65D 43/02; B65D 23/08

(57) ABSTRACT

An assembly that includes a first container having a first vessel body that includes: a first base having a first perimeter, a first side wall connected to the first base, and a first rim defined on the first side wall distal to the first base. The first container includes a cap that releasably engages the first rim. The assembly includes a second container having a second vessel body that includes: a second base having a second perimeter, a second side wall connected to the second base, and a second rim defined on the second side wall distal to the second base, wherein the cap of the first container is releasably engaged by the second base of the second container such that the cap is interposed between the first rim of the first container and the second base of the second container.

This application claims under 35 U.S.C. § 119(e)(1) the benefit of the priority date of Nov. 16, 2016 of U.S. Provisional Patent Application Ser. No. 62/423,059, the entire contents of which are incorporated herein by reference.

### BACKGROUND

The present invention is directed to a container, such as a beverage container like a wine glass, that can be sealed with a seal or lid that can be removed prior to consumption and also has a cap. The present invention also relates to assemblies of multiple such containers in a direct connected, attached configuration, wherein consecutive containers are attached to one another via a cap.

Beverages are commonly sold to consumers in containers such as glass or plastic bottles, aluminum or steel cans, cardboard or plastic cartons; or devices that include bladders containing the beverage. The beverage contained therein can be transferred to a suitable drinking glass composed of a suitable material including but not limited to glass, plastic, or the like for consumption. In certain situations, users prefer drinking beverages from individual serving containers such as cans, juice bottles and the like. However, many consumers prefer drinking certain types of beverages from glasses having wide mouths to enhance the aroma and, therefore, the flavor of the beverage.

It would be desirable to provide individual servings of various beverages in sealed wide-mouth containers to enhance the aroma and taste of the beverage during consumption. It is also desirable to provide individual serving containers that can be positioned together into multi-serving container packages for sale or distribution.

### SUMMARY

One aspect of the present invention regards an assembly having a first container that includes a first vessel body having a first base having a first perimeter, a first side wall connected to the first base, and a first rim defined on the first side wall distal to the first base. The first container further includes: a lid having a first seal region, the first seal region removably attached to the first rim; and a cap releasably engaged to the first lid. The assembly further includes a second container having a second vessel body that includes a second base having a second perimeter, a second side wall connected to the second base, and a second rim defined on the second side wall distal to the second base. The cap of the first container is releasably engaged by the second base of the second container such that the lid of the first container is interposed between the first rim of the first container and the second base of the second container.

A second aspect of the present invention regards an assembly that includes a first container having a first vessel body that includes: a first base having a first perimeter, a first side wall connected to the first base, and a first rim defined on the first side wall distal to the first base. The first container includes a cap that releasably engages the first rim. The assembly includes a second container having a second vessel body that includes: a second base having a second perimeter, a second side wall connected to the second base, and a second rim defined on the second side wall distal to the second base, wherein the cap of the first container is releasably engaged by the second base of the second container such that the cap is interposed between the first rim of the first container and the second base of the second container.

### BRIEF DESCRIPTION OF THE DRAWINGS

The various features, advantages and other uses of the present apparatus will become more apparent by referring to the following detailed description and drawing in which:

FIG. 1 is a perspective view of an embodiment of the beverage container as disclosed herein;

FIG. 2 is a side view of an embodiment of the beverage container of FIG. 1;

FIG. 3 is a top view of the beverage container of FIG. 1;

FIG. 4 is a detail view of an embodiment of a rim elevation of the beverage container of FIG. 1;

FIG. 5 is a cross-sectional view taken along the 5-5 line of FIG. 3;

FIG. 6 is a detail view of an embodiment the rim portion of the beverage container of FIG. 1;

FIG. 7 is a bottom view of the beverage container of FIG. 1;

FIG. 8 is a detail view of the bottom region of the beverage container of FIG. 1

FIG. 9 is detail view of the lip region of the beverage container of FIG. 1;

FIG. 10 schematically shows a second embodiment of a beverage container that engages another beverage container in accordance with the present invention;

FIG. 11 schematically shows a third embodiment of a beverage container that engages another beverage container in accordance with the present invention;

FIG. 12 schematically shows a perspective view of a fourth embodiment of a beverage container that engages another beverage container in accordance with the present invention;

FIG. 12a schematically shows a front, partial cross-sectional view of the beverage container engaging a second beverage container of FIG. 12;

FIG. 12b schematically shows a top cross-sectional view of the beverage container engaging a second beverage container of FIG. 12;

FIG. 13 is a perspective view an embodiment of a beverage container assembly as disclosed herein and in accordance with the present invention;

FIG. 14 is a front view of the beverage container assembly of FIG. 13;

FIG. 15 is a detail view of the junction between two of the beverage containers in the beverage container assembly of FIG. 13;

FIG. 16 is a perspective view an embodiment of a beverage container assembly system, wherein the beverage container assembly of FIG. 13 includes a removable cover in accordance with the present invention;

FIG. 17 is a front view of the beverage container assembly system of FIG. 16;

FIG. 18 is a top view of the beverage container assembly system of FIG. 16;

FIG. 19 is a top view of the beverage container assembly system of FIG. 16;

FIG. 20 is a side view of a beverage container as disclosed herein as an assembly with an embodiment of a removable beverage container accessory;

FIG. 21 is a detail view of the assembly of FIG. 20;

FIG. 22 is a perspective view of the containers of FIGS. 10-15 altered to have connecting members and engagement members;

FIG. 23 is a top view of a first possible configuration of four beverage containers of FIGS. 1-15 using the connecting and engagement members of FIG. 22;

FIG. 24 is a top view of a second possible configuration of four beverage containers of FIGS. 1-15 using the connecting and engagement members of FIG. 22;

FIG. 25 shows a picture of a perspective view of an embodiment of a cap in accordance with the present invention;

FIG. 26 shows a picture of a side perspective view of the cap of FIG. 25;

FIG. 27 shows a picture of a perspective view of the beverage container of FIG. 1 when the lid is enclosed by the cap of FIG. 25;

FIG. 28 shows a picture of a perspective view of the beverage container of FIG. 27 prior to being stacked on a stack of like beverage containers that are stacked by use of the cap of FIG. 25;

FIG. 29 shows a picture of a perspective view of a stack of like beverage containers when the beverage container of FIG. 27 has been stacked on the stack of like beverage containers of FIG. 28, wherein such stacking is by use of the cap of FIG. 25;

FIG. 30A schematically shows a side view of the stack of like beverage containers of FIG. 29 when a partial cross-sectional view is shown;

FIG. 30B shows an enlarged view of the partial cross-sectional view of FIG. 30A;

FIGS. 30C-D show a top perspective view of the cap of FIG. 25;

FIGS. 30E-F show a bottom perspective view of the cap of FIG. 25;

FIG. 30G schematically shows a side view of the cap of FIG. 25 when a partial cross-sectional view is shown;

FIG. 30H is an enlarged view of the partial cross-sectional view of FIG. 30G;

FIG. 30I shows a cross-sectional view of the stack of FIG. 30A;

FIG. 31 shows a picture of a top, perspective view of a second embodiment of a cap in accordance with the present invention;

FIG. 32 shows a picture of a side view of the cap of FIG. 31;

FIG. 33 shows a picture of a top view of the cap of FIG. 31;

FIG. 34 shows a picture of a bottom, perspective view of the cap of FIG. 31;

FIG. 35 shows a picture of a bottom view of the cap of FIG. 31;

FIG. 36 shows a side cross-sectional view of the cap of FIG. 31;

FIG. 37 schematically shows an enlarged portion of the cross-sectional view of FIG. 36;

FIG. 38 schematically shows a side view of a stack of like beverage containers that employ the cap of FIGS. 31-37, wherein a partial cross-sectional view is shown; and

FIG. 39 shows an enlarged view of the partial cross-sectional view of FIG. 38.

### DETAILED DESCRIPTION

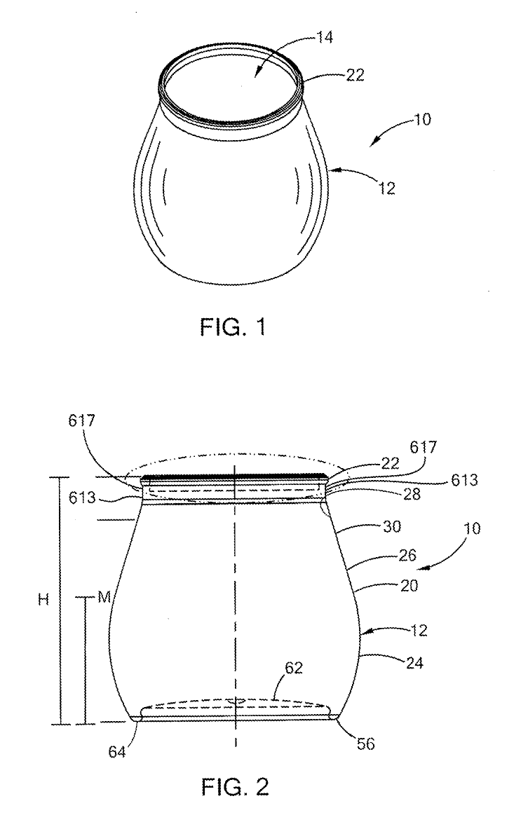

As shown in the exemplary drawing figures, and referring particularly for FIG. 1, a container such as beverage container 10 includes a beverage vessel body 12 and a removable lid 14 sealingly affixed to the beverage vessel body 12. An example of such a container 10 is disclosed in U.S. patent application Ser. No. 13/474,376, filed on May 17, 2012, the entire contents of which are incorporated herein by reference. The beverage vessel body 12 can be constructed of any suitable material. In various embodiments, the beverage vessel body 12 can be made of a suitable moldable polymeric material. Where desired or required, the material can be transparent. In specific embodiments, the material employed can be any material that is suitable for use with food stuffs. The material can be one that is dimensionally stable, but can provide minor deformation in specific applications. In applications where the beverage container 10 contains wine, the beverage vessel body 12 can be composed of a suitable transparent polymeric material. The lid 14 can be made of any suitable material including, but not limited to, foil, plastic and the like. The material employed in the lid 14 can be made of a material that is the same or different from the material of the vessel body 12. In some applications, it is contemplated that the material employed in the lid 14 will be more deformable than that employed in the vessel body 12 and will be able to conform to suitable dimensional contours by crimping or the like.

Note that while the beverage container 10 is designed to contain wine, it can contain other liquids, such as teas and juices. Furthermore, the container 10 can house other edible products, such as snacks, cereal, candy, etc. And, of course, the container 10 can house non-edible items, such as toys, office supplies, etc.

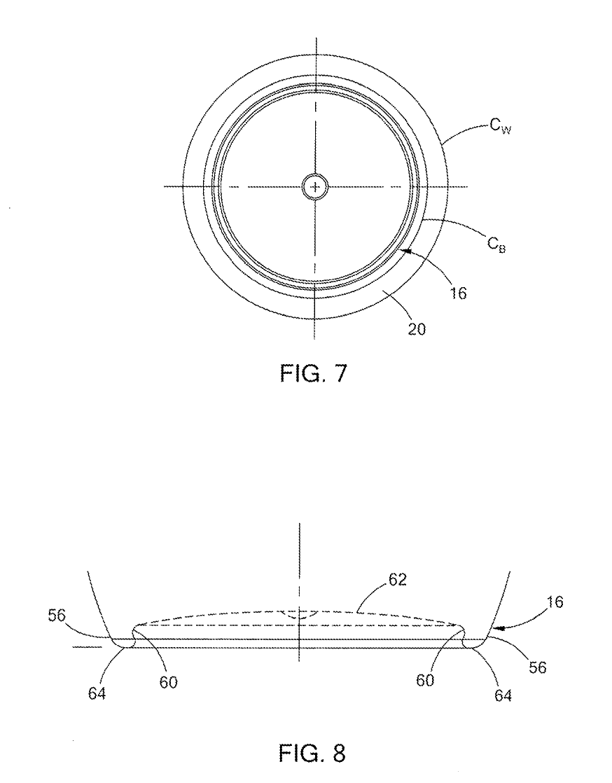

The beverage vessel body 12 includes a base 16 that has a circumference C_{B} as measured at the outer perimeter of a surface contacting region that has of a first defined value (see FIG. 7). The beverage vessel body 12 also has a side wall 20 that terminates at a rim 22. The side wall 20 and base 16 define an interior chamber of a specified volume. As such, the side wall 20 will have a suitable height H. The side wall 20 also has a side wall median M as shown in FIG. 2.

In the embodiments depicted in the drawing figures, the side wall 20 has a curvilinear outer contour that creates at least one outwardly protecting bulbous region 24 that extends beyond the perimeter created by the base 16. The side wall 20 has an inwardly tapering region 26 immediately above bulbous region 24 as shown in FIG. 2. Tapering region 26 terminates at rim 22, the geometry of which will be described in greater detail subsequently. In the embodiment depicted, the side wall 20 has bulbous region 24 located below the side wall height median M. Bulbous region 24 has a circumference C_{W} greater than the circumference C_{B} of base 16 as shown in FIG. 7. The side wall 20 curves upward from base 16 to the circumference maxima at C_{W}. The side wall 20 then enters a gentle inward curve that proceeds contiguously into tapering region 26. Circumference maxima at C_{W} can be any percentage greater than that of the circumference C_{B} of base 16. In certain embodiments, it is contemplated that the circumference maxima C_{W} can be between 10 and 50% greater than the circumference C_{B} of base 16.

The side wall 20 has an inwardly tapering region 26 between the bulbous region 24 and the rim 22. In the embodiment depicted, the rim 22 has a circumference maxima C_{R} equal to or less than the circumference C_{B} of the base 16. In the embodiment depicted in the drawing figures, the outer circumference or circumference maxima C_{R} of the rim 22 will be between 0 and 15% less than the circumference C_{R} of base 16. In certain embodiments, the maximum circumference C_{W} of side wall 20 will be between 5% and 50% greater than the circumference C_{B} of base 16.

As shown in FIG. 2, side wall 20 can have a suitable inner face 28 opposed to a curvilinear outer face 30. In certain various embodiments, the inner and outer faces will be parallel. In the case of parallel inner and outer faces, the internal chamber defined in vessel body 12 will have greater volume in the regions below the median M.

The internal volume of the vessel body 12 contained in the internal chamber generally will be suitable to contain a suitable beverage serving. The vessel body 12 will be proportioned in a manner that provides the suitable volume. In certain embodiments, it is contemplated that the base 16 will have a cross-sectional diameter between 2 and 4 inches. The outer diameter of rim 22 will be sufficient to permit releasable engagement between rim 22 of one container 10 and base 16 of a second container. The inner diameter of the rim 22 will be sufficient to permit the beverage to be consumed from the vessel body 12. The maximum diameter of side wall 20 in the bulbous region 24 can be between ¼ inch and 1 inch greater than the diameter of base 16. The total height of the beverage container will be one that approximates the height of a 6 oz. beverage glass in certain applications.

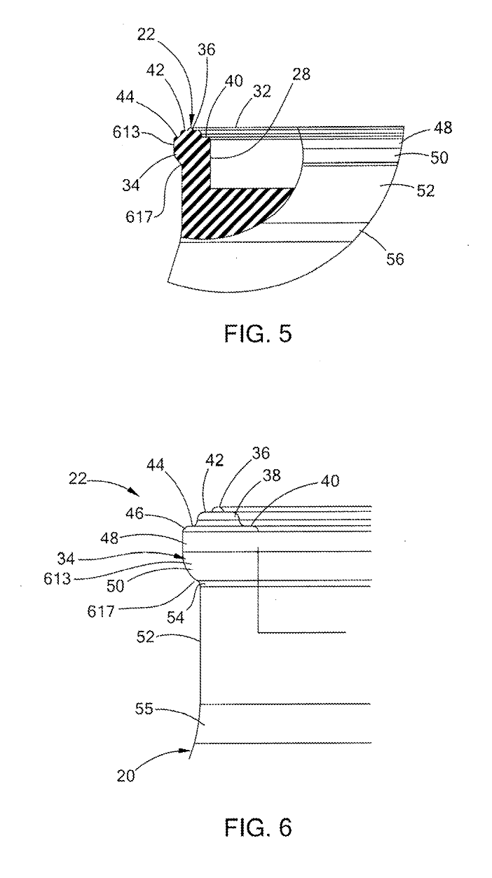

Rim 22 is contiguously joined to the upper region of side wall 20. As depicted in FIGS. 5-6, rim 22 includes a body 32 with a lip 34 projecting axially outward therefrom to a defined distance. In the embodiment depicted in the drawing figures, the lip 34 extends to provide an outer surface that can be received in a suitable orifice defined in the base 16 of a corresponding beverage vessel. In certain embodiments, the outer diameter of rim 22 is essentially equal to an inner diameter defined by base 16. The rim 22 also has an upwardly oriented surface that can include at least one upwardly oriented surface or bead 36 projecting therefrom.

Rim 22 is configured to be placed in mating contact with the lid 14 in a manner that facilitates establishment of a removed seal. It is contemplated that while lid 14 can be used when non-edible items are present within container 10, lid 14 would be preferably used when edible items, such as food and wine, are housed within container 10. Lid 14 can contact rim 22 in any suitable manner. In certain embodiments, the lid 14 is configured with a suitable edge region that is affixed to the rim 22 to maintain the beverage inside that vessel body 12. The lid 14 can be attached to the rim 22 in any suitable manner including, but not limited to, crimping adhesives and the like. Where an adhesive material is employed, the suitable adhesive material will be one that is suitable for use with food stuffs. The adhesive material can be present as a layer, bead, or other structure that is interposed between the rim 22 and the interior facing side of lid 14. Where desired or required, the interposed adhesive can be positioned such that it contacts all or a portion of the upper surface of rim 22, such as bead 36.

The lid 14 can have any suitable configuration to sealingly engage the rim 14 and span the opening defined in the vessel body 12. In various embodiments, the lid 14 can be a thin planar member that can conform to and cover the defined opening. For example, the lid 14 can be made of a foil-like material that has a tab that extends beyond the bead so that a user can grasp the tab and remove the lid 14. When in sealing engagement, the lid 14 can deflect inward into the opening defined in the vessel body 12. The lid 14 can have a suitable peripheral region proximate to its outer edge that can be configured to conform to at least a portion of the rim 22.

The desired beverage can be sealed in the vessel body 12 by lid 14. The volume of beverage will be such that the height of the beverage comes to a suitable fill line F. When the vessel body is composed of a suitable transparent polymeric material, the beverage will be visible through the vessel body 12. As mentioned previously, that besides liquids, the vessel body 12 can contain other types of objects, such as solid foods.

The rim 22 can have any configuration that will facilitate sealing engagement between the lid 14 and the vessel body 12. In one configuration, the rim 22 can include a generally vertical neck portion with a bead present at an end thereof. In another embodiment shown in FIGS. 5-6, the rim 22 can be configured with a plurality of steps 40, 42 positioned on interiorly and exteriorly oriented surfaces relative to bead 36. It is contemplated that adhesives or other sealing material can be interposed between the interiorly oriented steps 40, 42 and lid 14. As used herein the term “adhere” is taken to include connection facilitated by direct rim-to-lid adhesion as well as interposition of a suitable adhesive layer between the rim 22 and the lid 14. Where a line of adhesive is used, it is contemplated that the adhesive line can be deployed so as to contact the bead 36 of rim 22 and, if desired, the adhesive can be disposed such that the adhesive contacts multiple planar surfaces defined in the inwardly oriented surface of the rim 22.

It is also within the purview of this disclosure to configure lid 14 to conform to one or more of the geometric ridges and/or shelves defined in the upper surface of the rim 22. Conformance can be accomplished during manufacture of lid 14 or during attachment of lid 14 to associated rim 22. Conformance fitting may be augmented by adhesives where desired or required.

In the embodiment depicted in FIG. 4-6, the rim 22 has at least one shoulder 38 radially interior of the bead 36. The shoulder 38 is has a maximum height or peak below bead 36. Shelf 40 is located radially interior to shoulder 38 and is positioned contiguous thereto. Shelf 40 terminates in a downwardly projecting upper portion of inner wall 28.

Where desired or required, the rim 22 can have suitable outer geometric details. In the embodiment depicted in FIGS. 4-6, the rim 22 has a shoulder 42 radially outward of bead 36 and positioned below the bead 36. A shelf 44 is positioned radially outward of and below the shoulder 42 and is contiguously joined to it. The contours of the various shelves 40, 44 and shoulders 38, 42 will be sufficient to permit contact with lid 14, but will be small enough to permit an enjoyable drinking experience.

While an adhesive attachment between the lid 14 and the associated rim 22 has been previously described, other types of attachment are possible. For example, an outer edge of the lid 14 could be crimped like a beer bottle cap so as to engage an exterior side of the rim 22. Another possibility is to slightly melt the top layer of the rim 22 and/or the bottom of the lid 14 prior to placing the lid 14 thereon so that a seal is formed between the lid 14 and rim 22.

The outer edge 46 of shelf 44 defines a downwardly extending wall region 48 that terminates in an inwardly curved lower region 50. In the embodiment depicted in FIGS. 5-6, the inwardly curved lower region 50 terminates in a cylindrical band portion 52 that is interposed between the rim 22 and the uppermost portion of side wall 20. Side wall 20 and cylindrical band portion 52 can be contiguous to one another or can have a suitable intermediate region 54 interposed between them. In the embodiment depicted in the various drawing figures, an inwardly tapered is interposed between the intermediate region 54 inwardly curved lower region 50 and the cylindrical band portion 52.

The vessel body 12 can also include a transitional region 55 interposed between band portion 52 and the upper region of side wall 20.

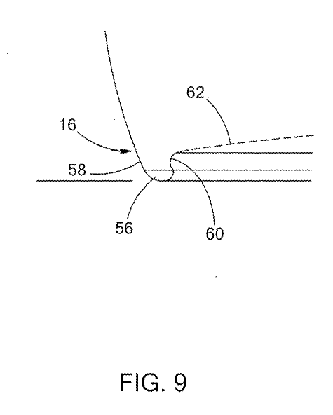

The base 16 of vessel body 12 can be configured to releasably engage with rim 22 of a similarly configured beverage vessel 10. In the embodiment depicted in FIGS. 8-9, the base 16 includes at least one arm member 56 having an outwardly oriented side 58 contiguously connected to the lower region of the side wall 20 at a location on vessel body 12 opposed to the rim 22. The arm member 56 defines an inwardly oriented detent 60 generally opposed to outwardly oriented side 58 that terminates in bottom wall (shown in phantom in FIGS. 8 and 9). The size, number and positioning of arm member(s) 56 is sufficient to releasably engage the rim 22 of a corresponding beverage container 10. As depicted in FIGS. 7, 8 and 9, the device has one arm member 56 that extends continuously around the circumference of the base 16 and defines a surface contacting region 64.

The detent 60 can have any suitable internal wall configuration sufficient to receive and maintain at least a portion of rim 22 of an associated beverage device 10 in engaged relationship. In the embodiment depicted, the internal wall of detent 60 has a concave configuration that can releasably engage the corresponding rim 22. In the embodiment depicted, the inner wall of detent 60 contacts the shoulder 50 associated with rim 22.

The arm member 56 can be either of solid or hollow construction depending on the specific application. In the embodiment depicted in the drawing figures, arm member 56 is a continuous solid circular body contiguously positioned relative to side wall 20 and bottom surface 62. Without being bound to any theory, it is believed that the solid continuous arm member 56 provides stability to the associated vessel body 12. It is further believed that solid continuous arm member 56, when employed with solid rim 22 as further associated with curve linear side wall 20 provides a structurally robust beverage container 10.

The bottom surface 62 (shown in phantom in FIGS. 2, 8 and 9) can have any suitable geometric configuration. In the embodiment set forth in the drawing figures, the bottom surface 62 has an inwardly curved geometry having a lowest region proximate to arm member 56 and a maximum inwardly oriented point proximate to the radial center of the device 10. The arc defined by curved bottom surface 62 is between 1 degree and 30 degrees from planar.

Engagement between rim 22 and the arm member 56 generally occurs at a junction point located at a lower portion of detent 60 and rounded shoulder region 50 of the respective elements.

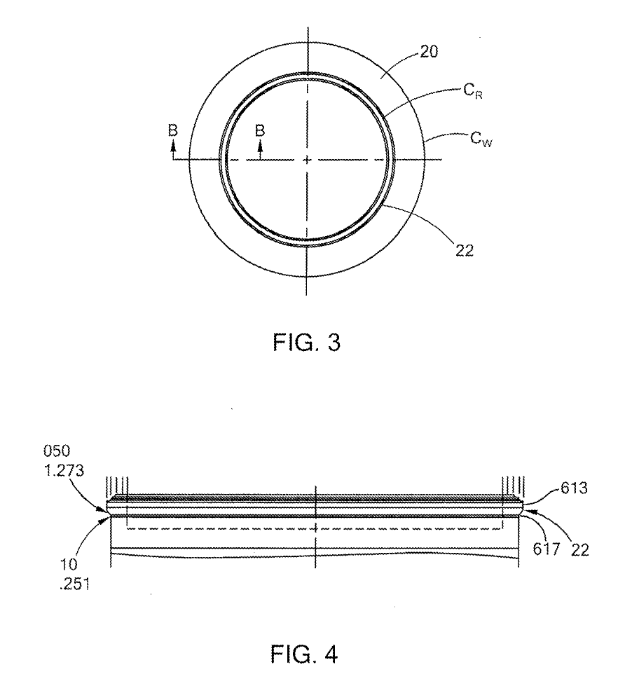

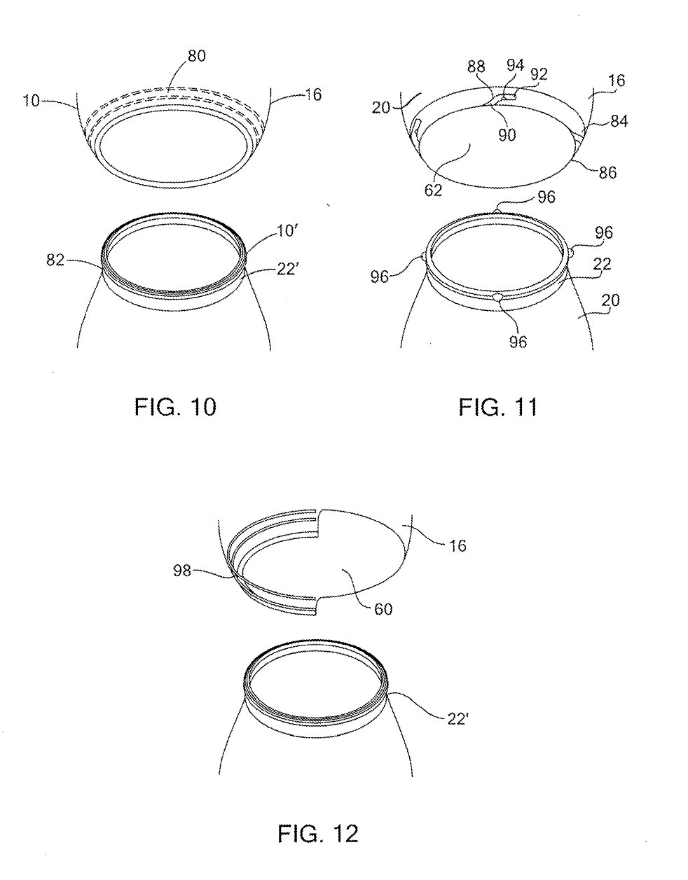

Note that other connections between a base 16 of one beverage container 10 and a rim 22′ of another beverage container 10′ are possible. For example, an interior side surface of the base 16 of one beverage container 10 of FIGS. 1-9 can be altered to have a threaded pattern 80 that is threadedly engaged by a threaded pattern 82 formed on an exterior surface of the rim 22′ of another beverage container 10′ as shown in FIG. 10. Thus, the beverage containers 10 and 10′ are screwed onto one another. Of course, the attachment scheme can be reversed where the threaded pattern 80 is formed on an exterior surface of the base 16 and the threaded pattern 82 is formed on an interior surface of the rim 22′, the base 16 dimensioned so that the threaded patterns can engage one another. So, in summary, the bases and rims of each of the beverage containers 10, 10′ of FIGS. 1-9 can be altered to include the threaded engagement disclosed above.

Another possible attachment scenario is shown in FIG. 11. In particular, the base 16 of FIGS. 1-9 is altered so an interior surface 84 of a lower portion of the side wall 20 defines a vertical surface. A bottom surface 62 is formed above the bottom edge 86 of the interior surface. As shown in FIG. 11, a channel 88 is formed in the interior surface 84, wherein one end 90 of the channel 88 is formed at the bottom edge 86 so that access to the channel 88 at the bottom edge 86 is possible. The channel 88 rises at an angle from the bottom edge 86 and then levels off at another end 92. Before leveling off, the channel 88 includes a protrusion 94. The channel 88 and protrusion 94 are dimensioned and structured so that when a nub 96 formed on the rim 22 of another container moves along the channel 88, the nub 96 is trapped in end 92 after the nub 96 passes the protrusion 94.

With the above structure in mind, attachment of the rim 22 of one container to the base 16 of another container is accomplished by inserting the rim 22 of one container within the interior surface 84 of another container. Next, the two containers are rotated relative to one another in a first direction until a nub 96 on the rim 22 of one container is inserted into the channel 88 of the other container and passes the protrusion 94. The containers are effectively locked to one another until relative rotation between the two containers is performed in a direction opposite to the first direction. If sufficient torque is applied, the nub 96 will pass the protrusion 94 and be fed to the bottom edge of the container where the rim 22 can be released.

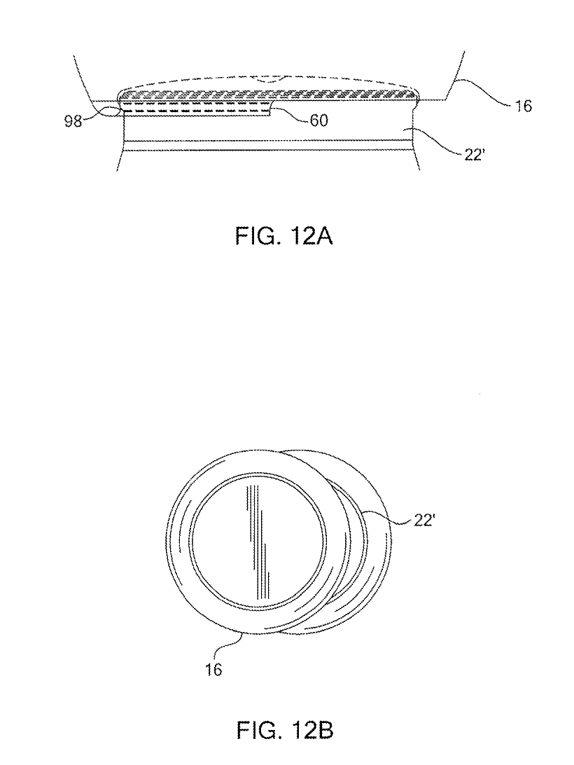

Another possible attachment scenario is shown in FIGS. 12a-b. In particular, the base 16 of FIGS. 1-9 is altered so that lower portion at the bottom edge extends approximately 180° so as to be C-shaped. So, in practice, the lid 22′ of one container is slid into the detent 60 until the rim 22′ reaches the rear portion 98 of the base 16. The rim 22′ and the base 16 are locked to one another by using a channel and nub system similar to that described with respect to FIG. 11. The structure of the channel formed in the interior of the side wall where the detent 60 is present is basically the same as that described with respect to the channel 88 of FIG. 11. One difference is that unlike protrusion 94 of FIG. 11, the protrusion is formed in the side of the channel 88 and not the bottom as shown in FIG. 11. With the above described channel described, locking between the rim 22′ and the base 16 is accomplished by sliding the rim 22′ into the detent 60 and then twisting the rim 22′ and base 16 relative to one another until a nub formed in the rim 22′ slides into the channel and rises up the channel until it moves over the protrusion into an end portion of the channel where the rim 22′ and base 16 are locked. Twisting in the opposite direction with sufficient torque will release the nub from the channel in the manner similar to that described previously with respect to FIG. 11.

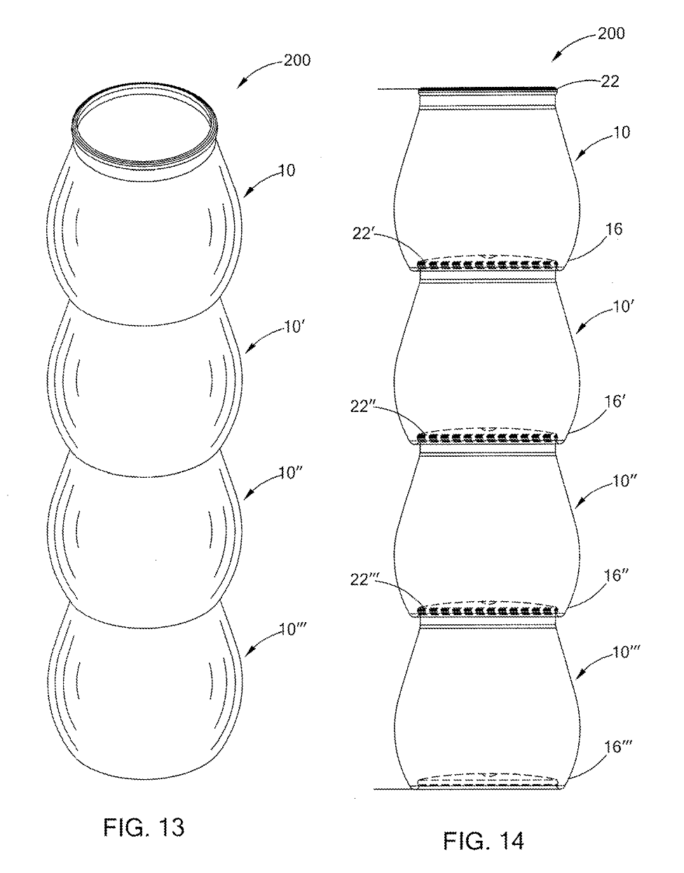

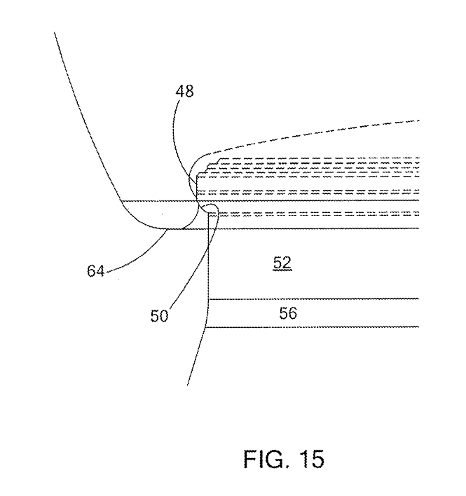

The present disclosure contemplates an assembly of beverage containers such as those previously described the assembly including at least two beverage containers each having a vessel body 12 and a lid 14. An example of such an assembly when the beverage containers of FIGS. 1-9 are used is shown in FIGS. 13-15. Each beverage container 10 has a serving of a given beverage located in a sealed chamber defined in the vessel body 12. The serving size can be a predetermined amount. In applications were the beverage container 10 is configured to contain wine, the serving size can be between 2 oz. and 6 oz. by way of example. In the assembly 200, as depicted in FIGS. 14 and 15, the base 16 of at least one first beverage container 10 releasably engages the rim 22′ of a second beverage container 10′ such that a lid 14′ of the second beverage container 10′ is interposed between the respective rim 22′ and base 16. In addition, note that the beverage container at the top of the stack may include a plastic cap to cover the lid.

The assembly 200 can be composed of any number of beverage containers 10, 10′. Certain assemblies can be composed of even multiples of beverage containers with assemblies of two and four being typical in certain applications. The assembly 200 of FIGS. 13-15 can further include an outer covering member. Non-limiting examples of outer covering include boxes and shrink wrap and the like.

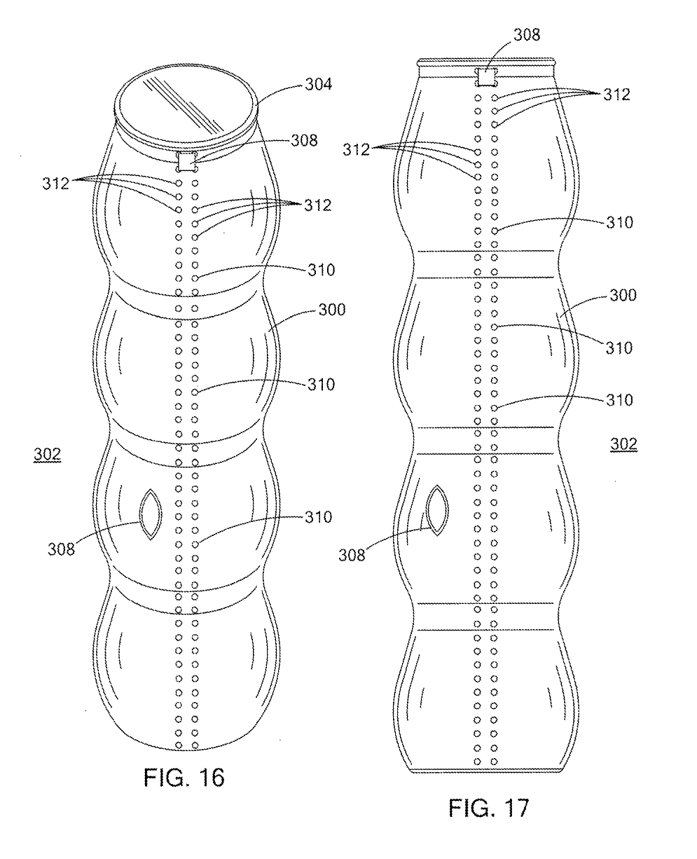

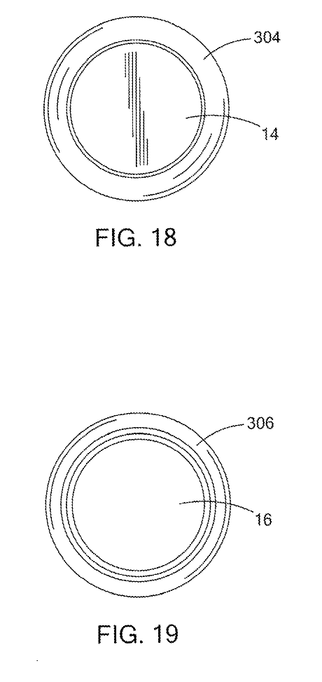

An example of a possible outer covering is shown in FIGS. 16-19. The outer covering 300 is made of a flexible, plastic material, such as PET, that has an opening at both ends thereof. The assembly 200 of FIGS. 13-15 is inserted bottom end first through the opening so that the covering 300 and assembly 200 define a covered assembly of beverage containers 302. In the case of using PET for covering 300, the covering 300 and assembly combination are placed in a steam tunnel or the like, which results in the covering shrinking and taking on the shape of the assembly of beverage containers. As shown in FIGS. 16-17, the material takes on the exterior shape of the assembly 200 along the sides. At the top, an annular ring 304 may be formed around the outer edge of the plastic cap attached to the lid 14 and rim 22. At the bottom, an annular portion 306 is centered about the center of the base 16. Note that the covering 300 may contain various features. For example, the covering 300 may include an opening 308 so that an observer can determine the contents within the covering 300. The covering 300 may include an opening device 310 that includes an area that extends along the length of the assembly 302 and the area is so weakened that when a user pulls on a tab area 308 at the top and along the length of the opening device the area breaks apart to reveal the beverage containers therein. As shown in FIGS. 16-17, the area includes two parallel lines of holes, wherein each hole 312 is approximately 1 mm in diameter and there are about 7 holes per every centimeter along the length of the area. As shown in FIGS. 16-17, each hole 312 is defined by a circular free edge formed in the covering 300. The lines of holes are separated from one another by approximately 8 mm. When the tab area 308 is pulled downward, the material along one of the lines of holes and between the holes of that line is broken apart. The same process occurs with the other line of holes so that a slit-like opening is formed between the lines of holes.

The beverage containers 10, 10′ etc. can be dimensioned to approximate the height and maximum width dimensions of a standard wine bottle. Thus an assembly 200 of four beverage containers 10, 10′, 10″, 10′″ positioned in stacked end-to-end relationship will have the approximate height of a standard wine bottle. The assembly can contain four servings of the same or different wines. Each container can be accessed by removing the respective lid. The contents can be consumed from the opened beverage container which can be used as a drinking glass.

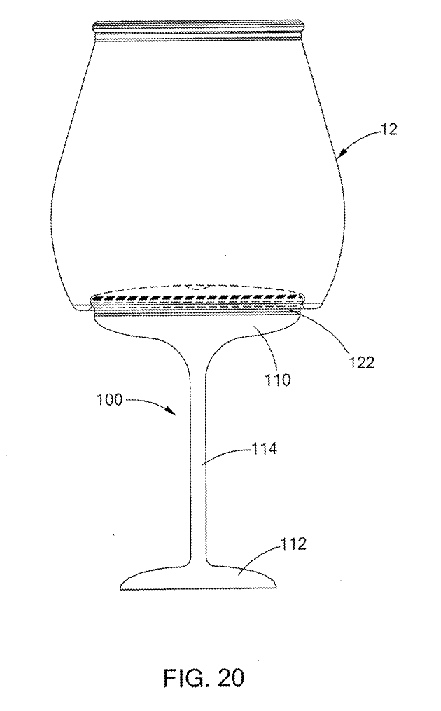

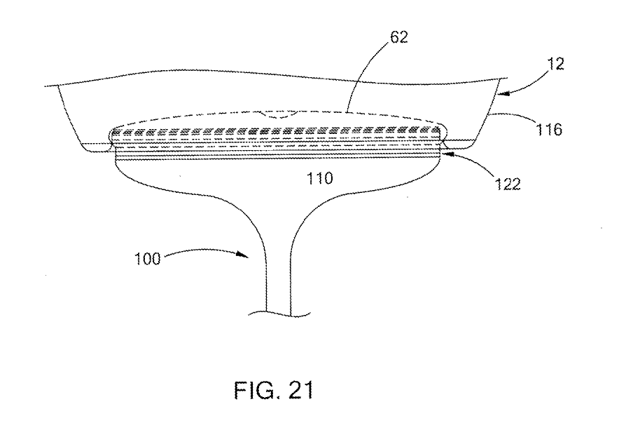

While the present disclosure has presented engagement between two beverage containers 10, it is also considered within the purview of the present disclosure to provide releasable engagement between a beverage container 10 and a suitable accessory. One non-limiting example of a suitable accessory to be engaged by the beverage container 10 of FIGS. 1-9 is wine glass support 100 depicted in FIGS. 20 and 21. Wine glass support 100 includes a suitable head 110, base 112 and stem 114 interposed between head 110 and base 112. Head 110 is configured to releasably engage a suitably configured base 16 of beverage container 10. In the embodiment depicted, head 110 of wine glass support 100 includes a suitable rim 122 configured to matingly contact arm member(s) 56. In the embodiment illustrated, rim 122 is matingly received in the orifice defined by continuous circular arm member 56 in the manner described previously. Other accessories are contemplated, including but not limited to Pilsner stems as well as plate members and the like.

When the beverage container 10 is employed with an accessory such as wine glass support 100, the support 100 can be attached when desired. Typically the support 100 will be attached to base 16 of beverage container 10 prior to removal of lid 14.

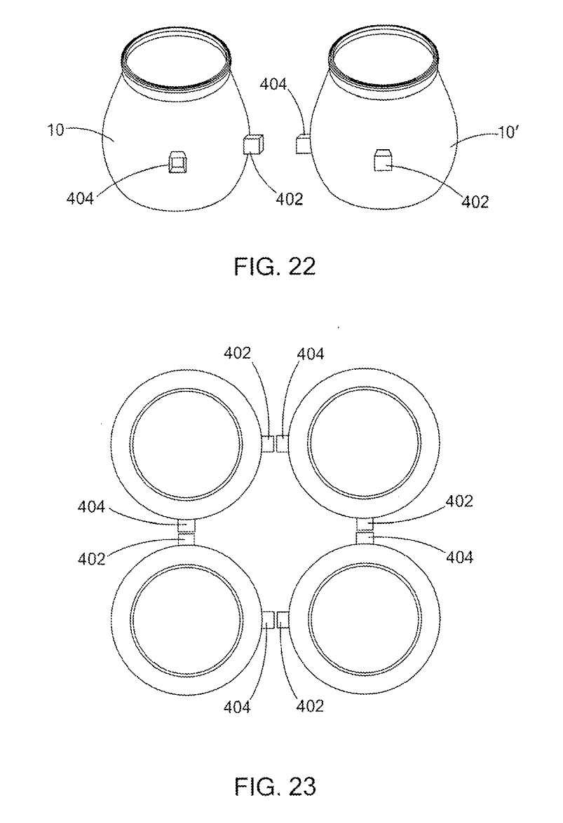

As previously described with respect to the beverage containers 10 and system 200 of FIGS. 1-15, attachment between the lids/rims of one container with the base of another container is possible. Further attachments are possible. As shown in FIG. 22, it is contemplated that the container 10 of FIGS. 1-15 are adapted to include one or more connecting members 402 on the side wall 20. Such connecting members 402 are adapted to engage with engagement members 404 of another container 10′. For example, it is contemplated that connecting member 402 would be a male member of a snap and attachment member 404 would be a corresponding female member of the snap. Of course other engagement structures for members 402 and 404 are possible.

Note that the above described side engagement allows for a variety of packaging configurations, one of which is shown in FIG. 23. Another pattern would be to connect each container 10 side-to-side along a line using members 402 and 404 as shown in FIG. 24. If one of the unattached sides had a sufficient shape, such as a flat surface, the entire line of attached containers could be rotated so that the previously mentioned unattached side was placed on a surface so that the line of containers extended vertically from that surface so as to define a stack similar to those shown in FIGS. 13 and 14.

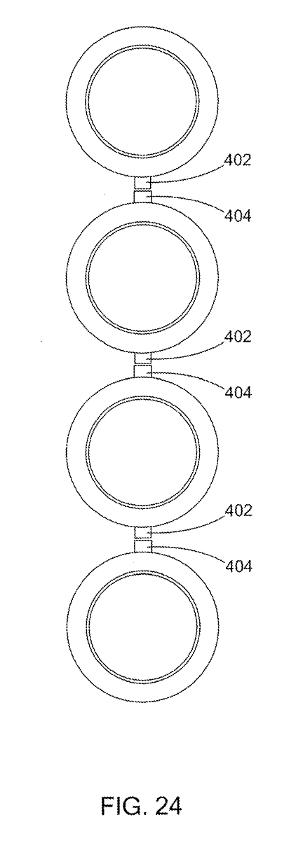

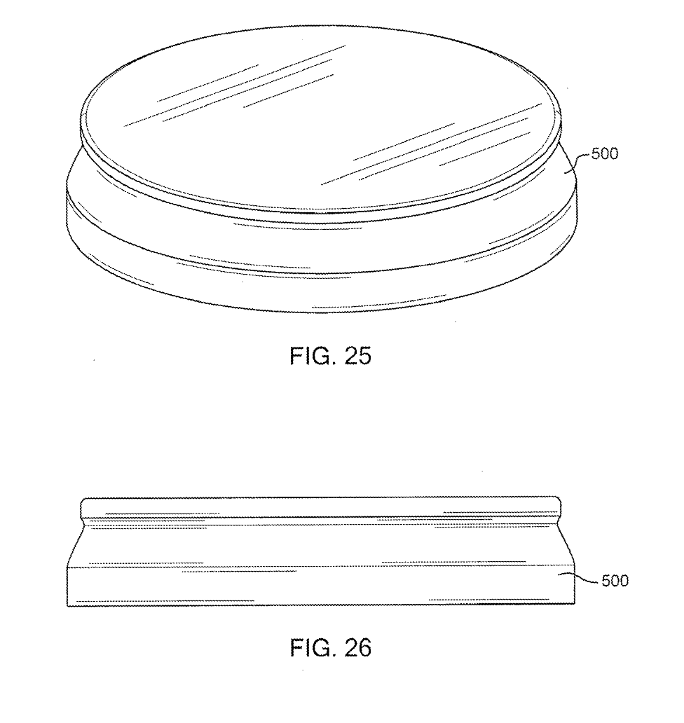

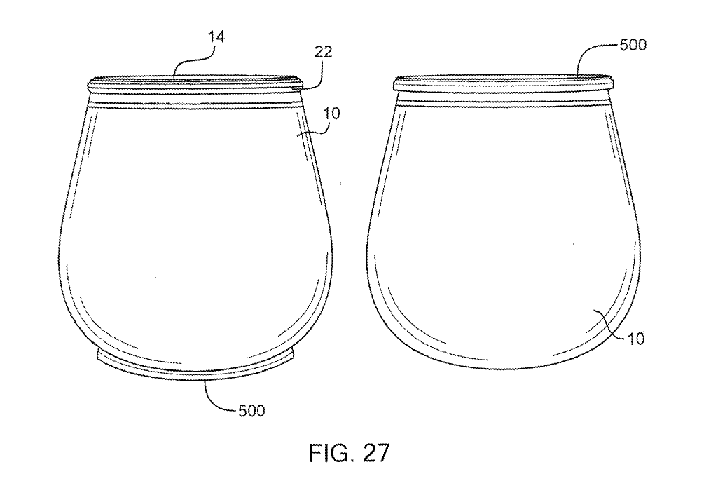

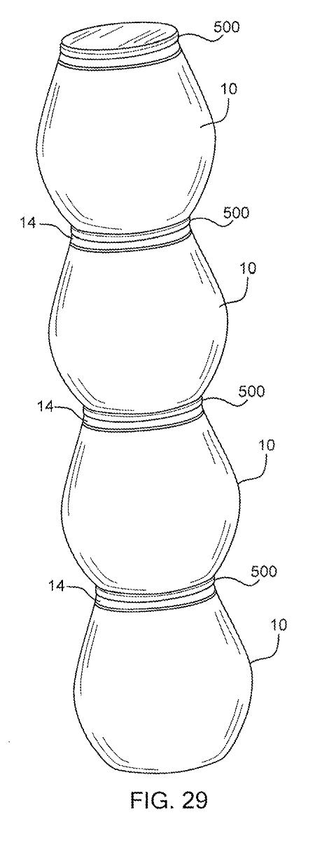

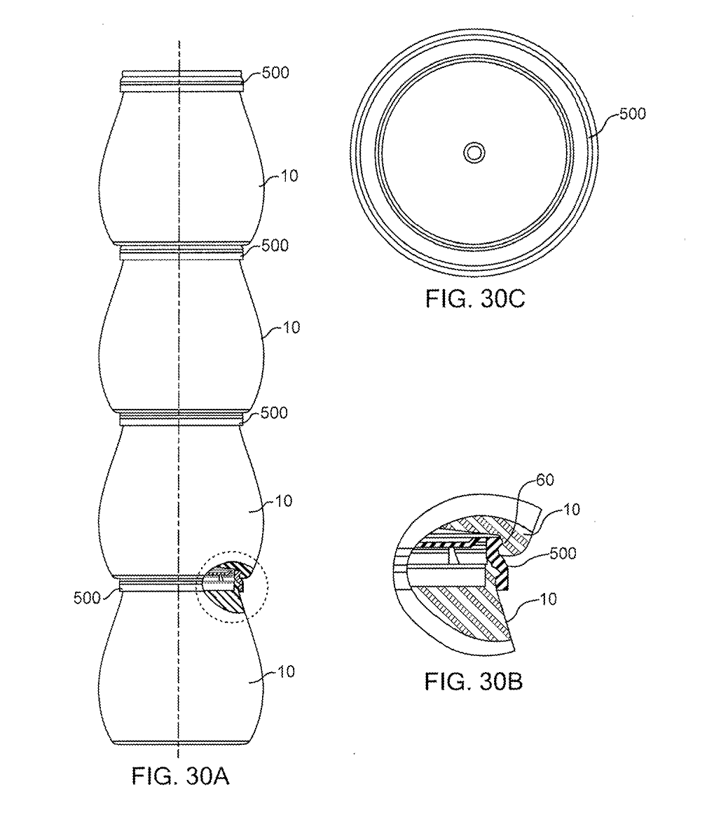

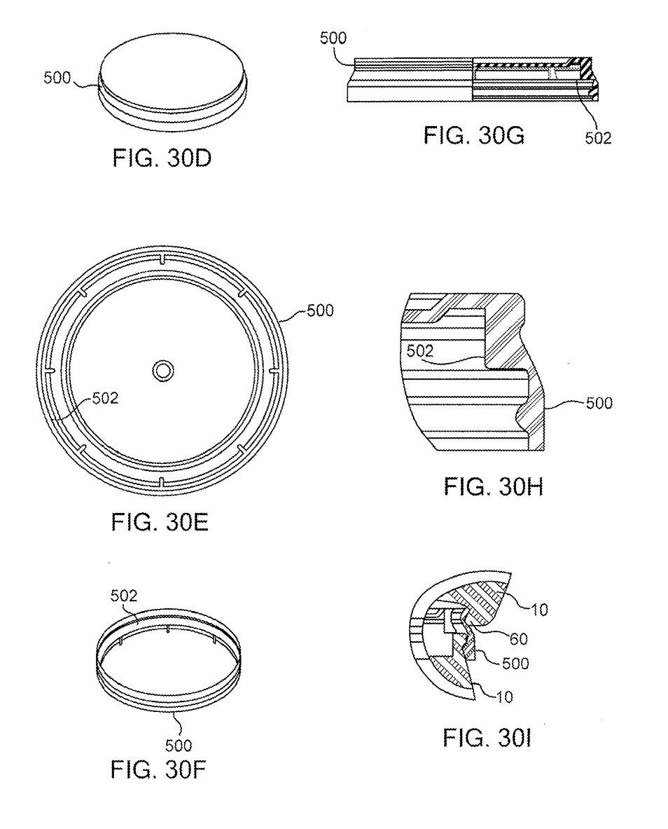

FIGS. 25-30 show another embodiment for stacking containers. In particular, a clear, plastic cap 500 as shown in FIGS. 25, 26 and 30 has an interior wall 502 that engages the rim 22 of the container 10 of FIGS. 1-9 (see FIGS. 30A, B and I, wherein the unbracketed dimensions shown in FIGS. 30A-I are in inches and the bracketed dimensions are in millimeters), while the lid 14 contacts the rim 22 in the manner described previously with respect to the container 10 of FIGS. 1-9. In other words, the cap 500 covers the lid 14 when the lid 14 contacts the rim 22. The container 10 with the cap 500 attached is shown in FIG. 27.

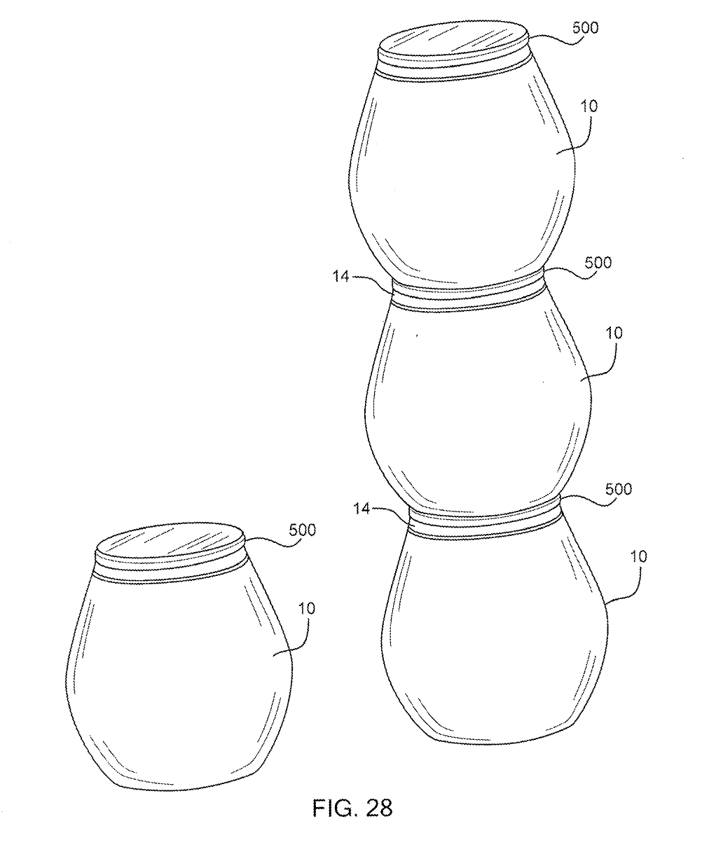

The container 10 of FIG. 27 can be attached to another container 10 alone or a stack of containers 10 as shown in FIGS. 28, 29 and 30A. Stacking is accomplished by having the detent 60 of an arm member 56 of a base 16 of the vessel body 12 of one container 10 engage an exterior side surface of the cap 500 as shown in FIGS. 30A, B and I. A stacked arrangement formed by the above process is shown in FIGS. 28, 29 and 30A. Note that the stacked arrangements shown in FIGS. 28, 29 and 30A can use the outer covering 300 as described previous with respect to FIGS. 16-19.

In use, a bottom or top container 10 of a stacked arrangement can be removed by the stack by pulling on the container 10 until the cap 500, which is used to attach the container 10 to the stacked arrangement, is no longer engaged with the detent 60 of the container 10 to which it was attached. The contents of the detached container 10 are accessed by removing the cap 500 and the lid 14 associated with the detached container 10. If desired, the interior wall 502 of the removed cap 500 can be oriented to engage the base 16 so that the cap 500 can act as a coaster for the container 10 as shown by the left container 10 of FIG. 27.

Note that while the embodiments described above describe the scenario wherein the lid 14 is present when cap 500 is used, there are envisioned scenarios where lid 14 is not used in combination with use of cap 500. Such a scenario can arise when the container 10 does not contain edible items. In such a scenario, two containers 10 are attached to one another in a stacked manner similar to that described previously by having the base 16 of an upper container 10 releasably engage the cap 500 of a lower container 10, when the cap 500 engages the rim 22 of the lower container 10. In such a stacked arrangement, the cap 500 will be interposed between the rim 22 of the lower container 10 and the base 16 of the upper container 10.

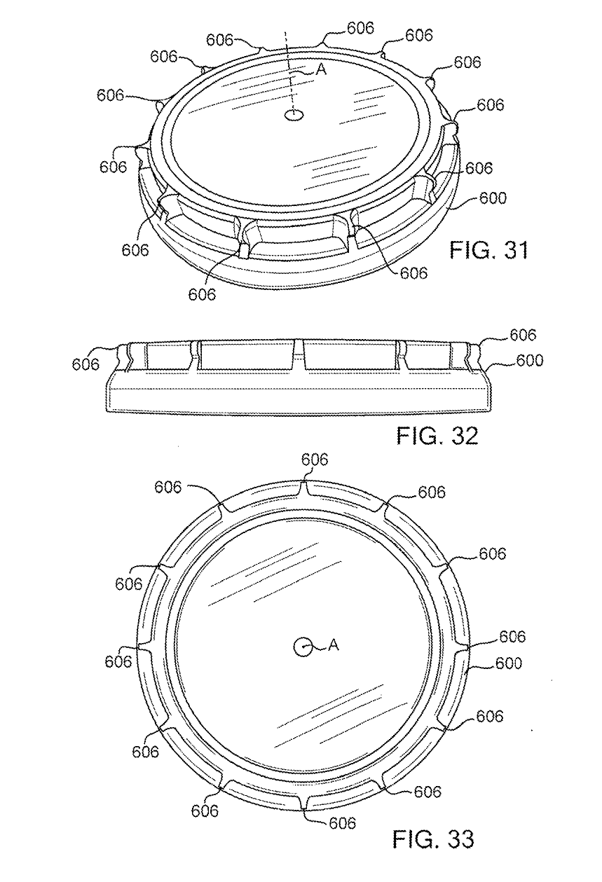

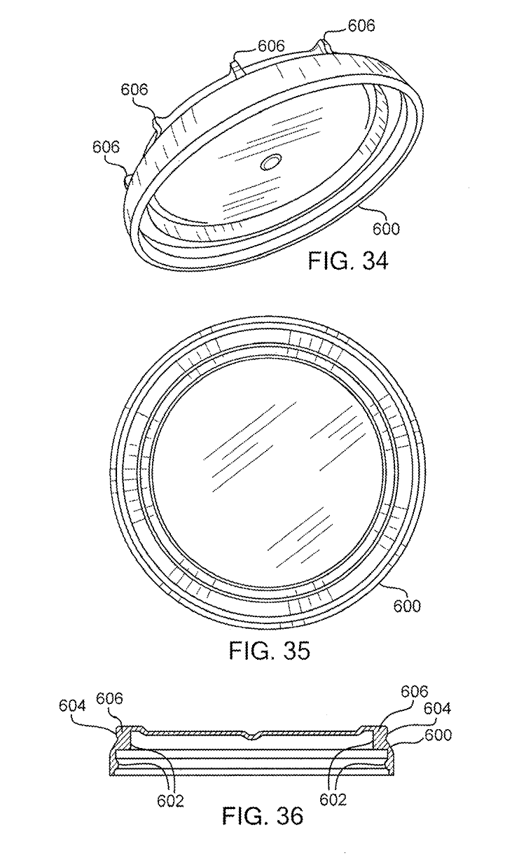

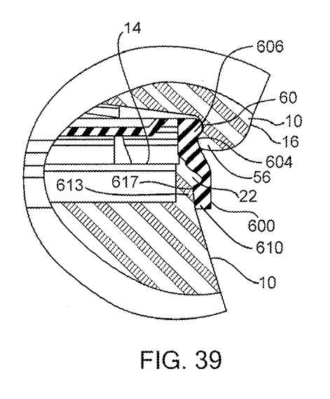

FIGS. 31-39 show another embodiment for stacking containers. In particular, a plastic cap 600 as shown in FIGS. 31-37 has an interior wall 602 that engages the rim 22 of the container 10 of FIGS. 1-9 as shown in FIGS. 38-39, while the lid 14 contacts the rim 22 in the manner described previously with respect to the containers 10 of FIGS. 1-9 and 25-30. In other words, the cap 600 covers the lid 14 when the lid 14 contacts the rim 22. The container 10 with the cap 600 attached is shown in FIGS. 38-39. Note that the cap 600 may be attached to the rim 22 by pressing the cap 600 downward so that an annular-like skirt 610 of the cap 600 is deformed outwards so that an inner surface 611 of the skirt 610 faces an exterior side face 613 of the rim 22. Then the material of the skirt 610 is such that the skirt 610 is forced against the face 613 in a spring-like manner. As shown in FIG. 39, an inner male member 615 engages an indentation 617 formed on the face 613 so that the cap 600 engages the rim 22 in a compressive manner. Removal of the cap 600 from the rim 22 is performed by moving the skirt 610 away from the rim 22 so that the male member 615 no longer engages the indentation 617 and then lifting the cap 600 away from the rim 22. Note that no helical threads or adhesive is used for attaching the cap 600 to the container 10.

The container 10 can be attached to another container 10 alone or a stack of containers 10 as shown in FIGS. 238-39. Stacking is accomplished by having the detent 60 of an arm member 56 of a base 16 of the vessel body 12 of one container 10 engage an exterior side surface of the cap 600 as shown in FIGS. 38-39. A stacked arrangement formed by the above process is shown in FIGS. 38-39. Note that the stacked arrangements shown in FIGS. 38-39 can use the outer covering 300 as described previous with respect to FIGS. 16-19.

Note that the exterior side surface of the cap 600 that is engaged by the detent 60 of the arm member 56 involves an exterior side surface 604 of a radially extending protrusion 606. As shown in FIGS. 31-34, there are a plurality of protrusions 606 present, such as twelve in number, which are separated from each other by an identical angle. The protrusions 606 are integrally formed from an inner, annular-like side wall 608 of the cap 600 that has a radius of approximately 0.950 inches as measured from the axis A. A lower surface of each protrusion 606 is integrally formed with the annular-like skirt 610 that has a radius of approximately 1.093 inches as measured from the axis A. Each protrusion 606 has a height as measured along a direction parallel to the axis A of approximately 0.18 inches. Each protrusion 606 has a notch 612 formed approximately midway along the length of the protrusion 606. As shown in FIG. 39, the arm 56 of the base 16 of a container 10 engages each of the notches 612 so that the detent 60 is only engaged by cap 600 at intermittent positions along its circumference. This is in contrast with the embodiment of FIGS. 25-30, wherein in that embodiment the detent 60 is engaged by the cap 500 at every position along its circumference. Note that the attachment between the cap 600 of one container 10 and the base 16 of another container 10 is a compressive attachment that is the result of the detent 60 of the base 16 being snap fitted into the notches 612 of the cap 600. Such attachment does not require relative rotation between the cap 600 and the base 16.

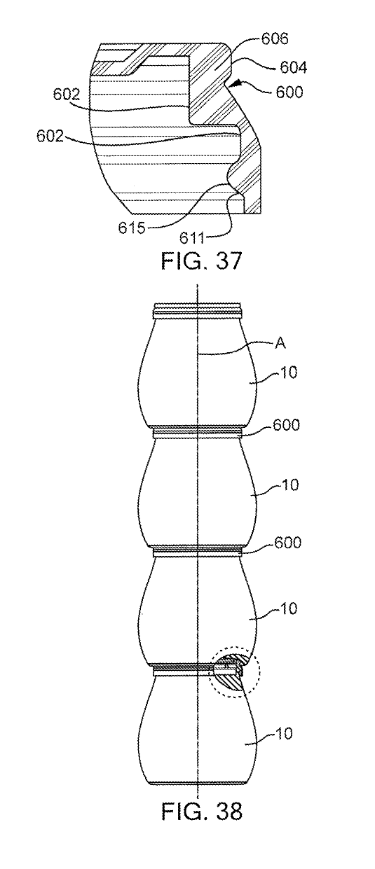

In use, a bottom or top container 10 of a stacked arrangement can be removed by the stack by pulling on the container 10 until the cap 600, which is used to attach the container 10 to the stacked arrangement, is no longer engaged with the detent 60 of the container 10 to which it was attached. The contents of the detached container 10 are accessed by removing the cap 600 and the lid 14 associated with the detached container 10. If desired, the interior wall 602 of the removed cap 600 can be oriented to engage the base 16 so that the cap 600 can act as a coaster for the container 10 in a manner similar to that shown by the left container 10 of FIG. 27. Note that the exterior wall 602 preferably has the same cross-sectional shape as shown in FIGS. 36-37 along any radial line emanating from the center of a plane that intersects the cap 600 and is perpendicular to the central, longitudinal axis A of the container 10.

Note that while the embodiments described above describe the scenario wherein the lid 14 is present when cap 600 is used, there are envisioned scenarios where lid 14 is not used in combination with use of cap 600. Such a scenario can arise when the container 10 does not contain edible items. In such a scenario, two containers 10 are attached to one another in a stacked manner similar to that described previously by having the base 16 of an upper container 10 releasably engage the cap 600 of a lower container 10, when the cap 600 engages the rim 22 of the lower container 10. In such a stacked arrangement, the cap 600 will be interposed between the rim 22 of the lower container 10 and the base 16 of the upper container 10.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An assembly comprising:
a first container comprising:
a first vessel body comprising:
a first base having a first perimeter;
a first side wall connected to the first base; and
a first rim defined on the first side wall distal to the first base,
a lid having a first seal region, the first seal region removably attached to the first rim; and
a cap releasably engaged to the first lid;
a second container comprising:
a second vessel body comprising:
a second base having a second perimeter;
a second side wall connected to the second base; and
a second rim defined on the second side wall distal to the second base, wherein the cap of the first container is releasably engaged by the second base of the second container such that the lid of the first container is interposed between the first rim of the first container and the second base of the second container.

2. The assembly of claim 1, wherein the first container and the second container each include a serving of wine.

3. The assembly of claim 1, further comprising a cover that encloses the first container and the second container, the cover comprising an opening device that when manually operated provides access to at least one of the first container and the second container.

4. The assembly of claim 3, wherein the opening device comprises two lines of holes formed in the cover and a tab area formed in the cover, wherein the holes and the tab area are structured so that when the tab area is pulled downward material along at least one of the lines of holes and between the holes of the line are broken apart so that a slit-like opening is formed between the lines of holes.

5. The assembly of claim 1, wherein the cap is releasably engaged at a finite number of positions by the second base.

6. The assembly of claim 1, wherein the finite number of positions are spaced from each other by an equal angle.

7. The assembly of claim 5, wherein at each of the finite number of positions on the cap there is a protrusion.

8. The assembly of claim 7, wherein each protrusion includes a notch that engages the second base.

9. The assembly of claim 8, wherein the second base defines a detent that engages each notch of the protrusions.

10. An assembly comprising:
a first container comprising:
a first vessel body comprising:
a first base having a first perimeter;
a first side wall connected to the first base; and
a first rim defined on the first side wall distal to the first base; and
a cap releasably engaged to the first rim;
a second container comprising:
a second vessel body comprising:
a second base having a second perimeter;
a second side wall connected to the second base; and
a second rim defined on the second side wall distal to the second base, wherein the cap of the first container is releasably engaged by the second base of the second container such that the cap is interposed between the first rim of the first container and the second base of the second container.

11. The assembly of claim 10, wherein the first container and the second container each include a serving of wine.

12. The assembly of claim 10, further comprising a cover that encloses the first container and the second container, the cover comprising an opening device that when manually operated provides access to at least one of the first container and the second container.

13. The assembly of claim 12, wherein the opening device comprises two lines of holes formed in the cover and a tab area formed in the cover, wherein the holes and the tab area are structured so that when the tab area is pulled downward material along at least one of the lines of holes and between the holes of the line are broken apart so that a slit-like opening is formed between the lines of holes.

14. The assembly of claim 10, wherein the cap is releasable engaged at a finite number of positions by the second base.

15. The assembly of claim 10, wherein the finite number of positions are spaced from each other by an equal angle.

16. The assembly of claim 15, wherein at each of the finite number of positions on the cap there is a protrusion.

17. The assembly of claim 16, wherein each protrusion includes a notch that engages the second base.

18. The assembly of claim 17, wherein the second base defines a detent that engages each notch of the protrusions.
